(19) United States
(12) Patent Application Publication
(10) Pub. No.: US 2009/0269645 A1
(43) Pub. Date: Oct. 29, 2009

(54) POLYMER, POLYMER ELECTROLYTE AND FUEL CELL USING THE SAME

(75) Inventor: Toru Onodera, Tsukuba-shi (JP)

Correspondence Address: BIRCH STEWART KOLASCH & BIRCH, PO BOX 747, FALLS CHURCH, VA, 22040-0747, US

(73) Assignee: SUMITOMO CHEMICAL COMPANY, LIMITED, Tokyo (JP)

(21) Appl. No.: 12/439,612

(22) PCT Filed: Sep. 4, 2007
(86) PCT No.: PCT/JP2007/067551

§ 371 Date: Mar. 2, 2009

(30) Foreign Application Priority Data
Sep. 5, 2006 (JP) 2006-239976

(51) Int. Cl. H01M 8/10; C08G 75/00; C08J 5/20

(52) U.S. Cl. 429/33; 528/391; 521/25; 521/27

(57) ABSTRACT

Provided is a polymer having a structural unit expressed by the following general formula (1a):

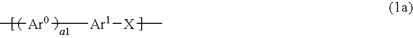

wherein a1 represents an integer of 1 or more; Ar¹ represents a divalent aromatic group having an ion-exchange group, and may have a substituent other than an ion-exchange group; Ar⁰ represents a divalent aromatic group that may have a substituent; when a1 is 2 or more, a plurality of Ar⁰s may be the same or different from each other; and X represents a divalent electron withdrawing group.

### TECHNICAL FIELD

The present invention relates to a polymer electrolyte, above all, to a polymer suitably used as a member for a fuel cell.

### BACKGROUND ART

As a material composing a separation membrane of an electrochemical device such as a primary cell, a secondary cell or a solid polymer fuel cell, a polymer having proton conductivity, namely a polymer electrolyte has been used. For example, to start with Nafion (trademark of DuPont Corporation), there has been mainly used a polymer electrolyte containing a polymer having perfluoroalkylsulfonic acid as a super strong acid in the side chain and whose main chain is a perfluoroalkane chain as an effective component, because the power generation characteristic is excellent when used as a separation membrane material for fuel cells. However, there have been pointed problems that this kind of material is very expensive, low in heat resistance, low in membrane strength, thus not practical without some sort of reinforcement.

In such situations, an inexpensive polymer electrolyte having excellent characteristics and capable of replacing the above-mentioned polymer electrolyte has been actively developed in recent years.

For example, proposed is a block copolymer having a segment into which a sulfonic acid group is not substantially introduced and a segment into which a sulfonic acid group is introduced, where the former segment consists of polyethersulfone, and the latter segment consists of an ether aggregate of diphenyl sulfone and a bisphenol having a sulfonic acid group as a repeating unit, and there is disclosed that when such a block copolymer is used as a proton-conducting membrane, variation in proton conductivity by humidity (hereinafter, sometimes called the “humidity dependence”) is small, and it can be suitably applied to fuel cells (for example, see Japanese Unexamined Patent Publication No. 2003-031232).

### DISCLOSURE OF THE INVENTION

However, the block copolymer disclosed in the above-described Japanese Unexamined Patent Publication No. 2003-031232 is not necessarily sufficiently small in humidity dependence of proton conductivity, and further the proton conductivity itself under low humidity is not sufficient.

An object of the present invention is to provide a polymer having very small humidity dependence of ionic conductivity in addition to high level of ionic conductivity when used as an electrolyte membrane. Further, another object is to provide a polymer electrolyte containing the polymer as an effective component, a member for a fuel cell using the polymer electrolyte, and a polymer electrolyte fuel cell using the member.

The present inventors keenly studied to find a polymer exhibiting more excellent performance as a polymer electrolyte applied to an ion-conducting membrane for fuel cells and so forth, and as a result, have completed the present invention.

That is, the present invention provides [1] a polymer having a structural unit expressed by the following general formula (1a):

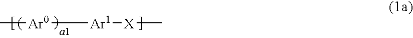

wherein a1 represents an integer of 1 or more; Ar¹ represents a divalent aromatic group having an ion-exchange group, and may have a substituent other than an ion-exchange group; Ar⁰ represents a divalent aromatic group that may have a substituent; when a1 is 2 or more, a plurality of Ar⁰s may be the same or different from each other; and X represents a divalent electron withdrawing group.

The polymer electrolyte membrane obtained from such a polymer has small humidity dependence of proton conductivity and is a very useful polymer electrolyte membrane in an application as a fuel cell.

The present invention provides the following [2] as a preferable mode of the above-described polymer.

[2] The polymer according to [1], having a structural unit expressed by the following general formula (1b) and a structural unit expressed by the following general formula (1c):

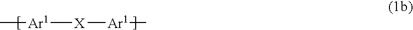

wherein Ar¹ and X have the same meanings as the above, and two Ar¹s may be the same or different from each other; and

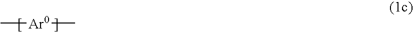

wherein Ar⁰ has the same meaning as the above.

The structural unit expressed by the foregoing general formula (1a) preferably has an ion-exchange group not only in Ar¹ adjacent to X but also in all of one or more Ar⁰s. Further, in this manner, it is more preferable that structural units containing an aromatic group having an ion-exchange group are linked to form a segment. Therefore, the following [3] to [5] are provided.

[3] The polymer according to [1], wherein the structural unit expressed by the foregoing general formula (1a) is a structural unit expressed by the following general formula (1);

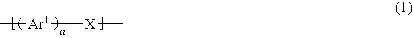

wherein a represents an integer of 2 or more; Ar¹ and X have the same meanings as the above; a plurality of Ar¹s may be the same or different from each other; and X represents a divalent electron withdrawing group.

[4] The polymer according to [3], having a segment expressed by the following general formula (2):

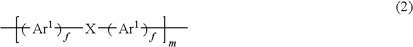

wherein Ar¹ and X have the same meanings as the above; f represents an integer of 1 or more, and two fs may be the same or different from each other; a plurality of Ar¹s may be the same or different from each other; and m represents the number of repeating units.

[5] The polymer according to [4], wherein m is an integer of 5 or more.

The present invention provides the following [6] to [8] as preferable embodiments regarding one of the foregoing polymers.

[6] The polymer according to any one of [1] to [5], wherein X is an electron withdrawing group selected from the group consisting of a carbonyl group, a sulfonyl group, and 1,1,1,3,3,3-hexafluoro-2,2-propylidene group.

[7] The polymer according to any one of [1] to [6], wherein the ion-exchange group at Ar¹ is directly bonded with an aromatic ring composing a main chain.

[8] The polymer according to any one of [1] to [7], wherein the ion-exchange group is an acid group selected from a sulfonic acid group, a sulfonimide group, a phosphonic acid group and a carboxyl group.

[9] The polymer according to any one of [1] to [8], wherein Ar¹ is an aromatic group expressed by the following general formula (4):

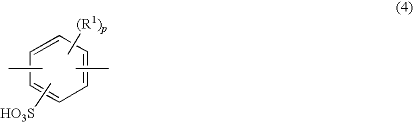

wherein R¹ is a fluorine atom, an alkyl group having 1 to 20 carbon atoms that may have a substituent, an alkoxy group having 1 to 20 carbon atoms that may have a substituent, an aryl group having 6 to 20 carbon atoms that may have a substituent, an aryloxy group having 6 to 20 carbon atoms that may have a substituent, or an acyl group having 2 to 20 carbon atoms that may have a substituent; and p is 0 or 1.

The present invention provides the following [10] and [11] as preferable embodiments regarding the foregoing [4] or [5].

[10] The polymer according to any one of [4] to [9], which has a segment expressed by the foregoing general formula (2) as a segment having an ion-exchange group, and further has a segment substantially not having an ion-exchange group, and wherein the copolymerization mode is block copolymerization.

[11] The polymer according to [10], wherein the segment substantially not having an ion-exchange group is a segment expressed by the following general formula (3):

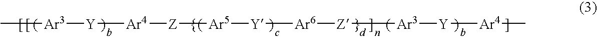

wherein b, c and d each independently represent 0 or 1, and n represents an integer of 5 or more; Ar³, Ar⁴ Ar⁵ and Ar⁶ each independently represent a divalent aromatic group, wherein these divalent aromatic groups may be substituted by an alkyl group having 1 to 20 carbon atoms that may have a substituent, an alkoxy group having 1 to 20 carbon atoms that may have a substituent, an aryl group having 6 to 20 carbon atoms that may have a substituent, an aryloxy group having 6 to 20 carbon atoms that may have a substituent, or an acyl group having 2 to 2-0 carbon atoms that may have a substituent; Y and Y′ each independently represent a direct bond or a divalent group; and Z and Z′ each independently represent an oxygen atom or a sulfur atom.

The polymer of the present invention is preferably controlled with respect to the ion-exchange capacity from the viewpoint of satisfying both higher ionic conductivity and water resistance as a member for a fuel cell. That is, the following [12] is provided.

[12] The polymer according to any one of [1] to [11], wherein an ion-exchange capacity is 0.5 meq/g to 4.0 meq/g.

Further, the present invention provides the following [13] to [18] obtained by using one of the foregoing polymers.

[13] A polymer electrolyte containing one of the foregoing polymers as an effective component.

[14] A polymer electrolyte membrane containing the polymer electrolyte according to [13].

[15] A polymer electrolyte composite membrane containing the polymer electrolyte according to [13] and a porous base material.

[16] A catalyst composition containing the polymer electrolyte according to [13] and a catalyst component.

[17] A polymer electrolyte fuel cell containing the polymer electrolyte membrane according to [14], or the polymer electrolyte composite membrane according to [15] as an ion-conducting membrane.

[18] A polymer electrolyte fuel cell provided with a catalyst layer obtained by using the catalyst composition according to [16].

The polymer of the present invention has small humidity dependence of ionic conductivity and can provide a suitable ion-conducting membrane when it is used as a member for a fuel cell, above all, as an ion-conducting membrane. This effect on humidity dependence is also suitable in the case where the polymer of the present invention is applied to a catalyst layer of polymer electrolyte fuel cells. In particular, in the case where an ion-exchange group of the polymer of the present invention is an acid group, when the polymer is used as a proton-conducting membrane for a fuel cell, the fuel cell can exhibit high power generation efficiency. As described above, the polymer of the present invention is industrially very useful particularly in an application as a fuel cell.

### BEST MODES FOR CARRYING OUT THE INVENTION

The polymer of the present invention is characterized by having a structural unit expressed by the following general formula (1a):

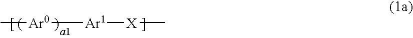

wherein a1 represents an integer of 1 or more, Ar¹ represents a divalent aromatic group having an ion-exchange group, and may have a substituent other than an ion-exchange group; Ar⁰ represents a divalent aromatic group that may have a substituent; when a1 is 2 or more, a plurality of Ar⁰s may be the same or different from each other; and X represents a divalent electron withdrawing group.

Herein, an “ion-exchange group” is a group exhibiting ionic conduction when the polymer of the present invention is used as an electrolyte membrane in the form of a membrane, and “having an ion-exchange group” is a concept including a mode where an ion-exchange group is directly bonded with an aromatic ring at Ar¹, or a mode where an ion-exchange group is bonded with an aromatic ring at Ar¹ via an atom or an atom group.

In the foregoing general formula (1a), an “electron withdrawing group” is a group in which a σ value of the Hammett rule is positive. In the present invention, an electron withdrawing group is suitably +0.01 or more in the Hammett substituent constant, particularly preferably —CO-(carbonyl group), —SO₂— (sulfonyl group), or −C(CF₃)₂— (1,1,1,3,3,3-hexafluoro-2,2-propylidene group).

The present inventors have found that the polymer having a structural unit expressed by the forgoing general formula (1a) can give a membrane with very small humidity dependence of ionic conductivity when it is converted into the form of a membrane. This, as a member for a fuel cell, can make a cell easy in operation even in a low humidity condition at start-up, and also when the humidity increases to some extent, can exhibit an excellent effect of obtaining stable power generation performance. When an aromatic group Ar¹ adjacent to an electron withdrawing group X has an ion-exchange group, although it is not certain, it is assumed that ionic dissociation of the ion-exchange group is improved by the electron withdrawing property of X, which exhibits such humidity dependence. To use as a member for fuel cells, there is a case requiring durability to peroxides and radicals generated in operation of fuel cells. The polymer having a structural unit expressed by the forgoing general formula (1a) is expected, also in this point, to be able to exhibit such an excellent effect as being excellent in durability from the effect of an electron withdrawing group X.

The membrane has excellent dimensional stability to water uptake as well, and it makes possible to markedly reduce stress of a polymer electrolyte membrane due to swelling by water uptake and shrinkage by drying resulting from repeating operation and stoppage of cells, so that deterioration of the membrane can be suppressed, thereby achieving longer life of a cell itself.

Ar⁰ represents a divalent aromatic group that may have a substituent. The substituent may be an ion-exchange group or a group having an ion-exchange group, and a1 represents an integer of 1 or more. The upper limit of a1 can be chosen in a range satisfying the foregoing suitable ion-exchange capacity depending on the kind of Ar⁰, particularly whether Ar⁰ has an ion-exchange group or not. In consideration of easiness in production as well, a1 is preferably not more than 10, and more preferably not more than 5, and further preferably not more than 3.

The polymer of the present invention may be a copolymer of a structural unit expressed by the forgoing general formula (1a) and other structural units. In the case of such a copolymer, it is preferable that the content of a structural unit expressed by the general formula (1a) is 5% by weight to 80% by weight, and when it is 15% by weight to 60% by weight, it is particularly preferable in the Case of use as a polymer electrolyte membrane for a fuel cell because water resistance is improved in addition to a high level of ionic conductivity.

It is particularly preferable that a divalent aromatic group Ar¹ having an ion-exchange group in the general formula (1a) is a monocyclic aromatic group. As the monocyclic aromatic group, for example, a 1,3-phenylene group, a 1,4-phenylene group and the like are listed.

Ar¹ is characterized by having an ion-exchange group, but may contain a substituent other than an ion-exchange group. As the substituent, there are listed a fluorine atom, an alkyl group having 1 to 20 carbon atoms that may have a substituent, an alkoxy group having 1 to 20 carbon atoms that may have a substituent, an aryl group having 6 to 20 carbon atoms that may have a substituent, an aryloxy group having 6 to 20 carbon atoms that may have a substituent, and an acyl group having 2 to 20 carbon atoms that may have a substituent.

As an alkyl group having 1 to 20 carbon atoms that may have a substituent, for example, there are listed alkyl groups having 1 to 20 carbon atoms such as a methyl group, an ethyl group, an n-propyl group, an isopropyl group, an n-butyl group, a sec-butyl group, an isobutyl group, an n-pentyl group, a 2,2-dimethylpropyl group, a cyclopentyl group, an n-hexyl group, a cyclohexyl group, a 2-methylpentyl group, a 2-ethylhexyl group, a nonyl group, a dodecyl group, a hexadecyl group, an octadecyl group and an icosyl group; and alkyl groups having not more than 20 carbon atoms in total in which the above groups are substituted with a fluorine atom, a hydroxyl group, a nitrile group, an amino group, a methoxy group, an ethoxy group, an isopropyloxy group, a phenyl group, a naphthyl group, a phenoxy group, a naphtyloxy group or the like.

As an alkoxy group having 1 to 20 carbon atoms that may have a substituent, for example, there are listed alkoxy groups having 1 to 20 carbon atoms such as a methoxy group, an ethoxy group, an n-propyloxy group, an isopropyloxy group, an n-butyloxy group, a sec-butyloxy group, a tert-butyloxy group, an iosbutyloxy group, an n-pentyloxy group, a 2,2-dimethylpropyloxy group, a cyclopentyloxy group, an n-hexyloxy group, a cyclohexyloxy group, a 2-methylpentyloxy group, a 2-ethylhexyloxy group, a dodecyloxy group, a hexadecyloxy group and an icosyloxy group; and alkoxy groups having not more than 20 carbon atoms in total in which the above groups are substituted with a fluorine atom, a hydroxyl group, a nitrile group, an amino group, a methoxy group, an ethoxy group, an isopropyloxy group, a phenyl group, a naphthyl group, a phenoxy group, a naphtyloxy group or the like.

AS an aryl group having 6 to 20 carbon atoms that may have a substituent, for example, there are listed aryl groups such as a phenyl group, a naphtyl group, a phenanthrenyl group and an anthracenyl group; and aryl groups having not more than 20 carbon atoms in total in which the above groups are substituted with a fluorine atom, a hydroxyl group, a nitrile group, an amino group, a methoxy group, an ethoxy group, an isopropyloxy group, a phenyl group, a naphthyl group, a phenoxy group, a naphtyloxy group or the like.

As an aryloxy group having 6 to 20 carbon atoms that may have a substituent, for example, there are listed aryloxy groups such as a phenoxy group, a naphtyloxy group, a phenanthrenyloxy group and an anthracenyloxy group; and aryloxy groups having not more than 20 carbon atoms in total in which the above groups are substituted with a fluorine atom, a hydroxyl group, a nitrile group, an amino group, a methoxy group, an ethoxy group, an isopropyloxy group, a phenyl group, a naphthyl group, a phenoxy group, a naphtyloxy group or the like.

As an acyl group having 2 to 20 carbon atoms that may have a substituent, for example, there are listed acyl groups having 2 to 20 carbon atoms such as an acetyl group, a propionyl group, a butyryl group, an isobutyryl group, a benzoyl group, a 1-naphthoyl group and a 2-naphthoyl group; and acyl groups having not more than 20 carbon atoms in total in which the above groups are substituted with a fluorine atom, a hydroxyl group, a nitrile group, an amino group, a methoxy group, an ethoxy group, an isopropyloxy group, a phenyl group, a naphthyl group, a phenoxy group, a naphtyloxy group or the like.

As the ion-exchange group at Ar¹, both an acid group and a basic group can be adopted, but an acid group is generally used. As the acid group, acid groups such as a weak acid group, a strong acid group and a super strong acid group are listed, but a strong acid group and a super strong acid group are preferable. As examples of the acid group, for instance, there are listed weak acid groups such as a phosphonic acid group (—PO₃H₂) and a carboxyl group (—COOH); and strong acid groups such as a sulfonic acid group (—SO₃H), a sulfonimide group (—SO₂—NH—SO₂—R, wherein R represents a monovalent substituent such as an alkyl group or an aryl group), and above all, a sulfonic acid group or a sulfonimide group being a strong acid group is preferably used. By replacing a hydrogen atom on a substituent (—R) of Ar¹ and/or a sulfonimide group by an electron withdrawing group such as a fluorine atom, the foregoing strong acid group can function as a super strong acid group by the effect of the electron withdrawing group.

These ion-exchange groups may form salts by being replaced by metal ions or quaternary ammonium ions partly or entirely, and in the case of being used as a polymer electrolyte membrane for a fuel cell or the like, it is preferable that substantially all of the ion-exchange groups are in a free acid state.

Additionally, as described above, in a polymer having a structural unit expressed by the foregoing general formula (1a), the ion-exchange group may be directly bonded with an aromatic ring composing the main chain or may be bonded interposing a linking group, but direct bonding with an aromatic ring composing the main chain is preferable because the polymer of the present invention can be easily produced by using materials easily available from the market.

As described above, Ar⁰ in the general formula (1a) may be a divalent aromatic group having an ion-exchange group similar to Ar¹, or need not have an ion-exchange group. The other explanations are the same as in Ar¹.

In the case where the polymer of the present invention is a copolymer, the copolymerization mode may be random copolymerization, alternating copolymerization, block copolymerization or graft copolymerization, but above all, block copolymerization is preferable, and suitable polymers according to the block copolymerization will be described later.

In the foregoing general formula (1a), as described above, when an aromatic group Ar⁰ closer to an electron withdrawing group X has an ion-exchange group, it is expected that humidity dependence of ionic conductivity becomes better by an electron withdrawing effect in the same manner as in Ar¹. From such a viewpoint, it is preferable that Ar⁰ is also an aromatic group being an ion-exchange group, namely an aromatic group similar to Ar¹. In other words, a structural unit expressed by the foregoing general formula (1a) is preferably a structural unit expressed by the following general formula (1):

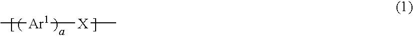

wherein a represents an integer of 2 or more; Ar¹ and X have the same meanings as the above; a plurality of Ar¹s may be the same or different from each other; and X represents a divalent electron withdrawing group.

Additionally, in a structural unit expressed by the foregoing general formula (1), the farther Ar¹ having an ion-exchange group is from an electron withdrawing group X, the harder it is to receive the electron withdrawing effect, so that a is preferably in a range of 2 to 4, and from the viewpoint of easy production, it is particularly preferable that a is 2.

Hereinafter, as a suitable structural unit, a structural unit expressed by the general formula (1) is explained.

Specifically, when a structural unit expressed by the general formula (1) is exemplified, the following (1-1) to (1-26) are listed (here, “-Ph” in (1-13) to (1-15) represents a phenyl group).

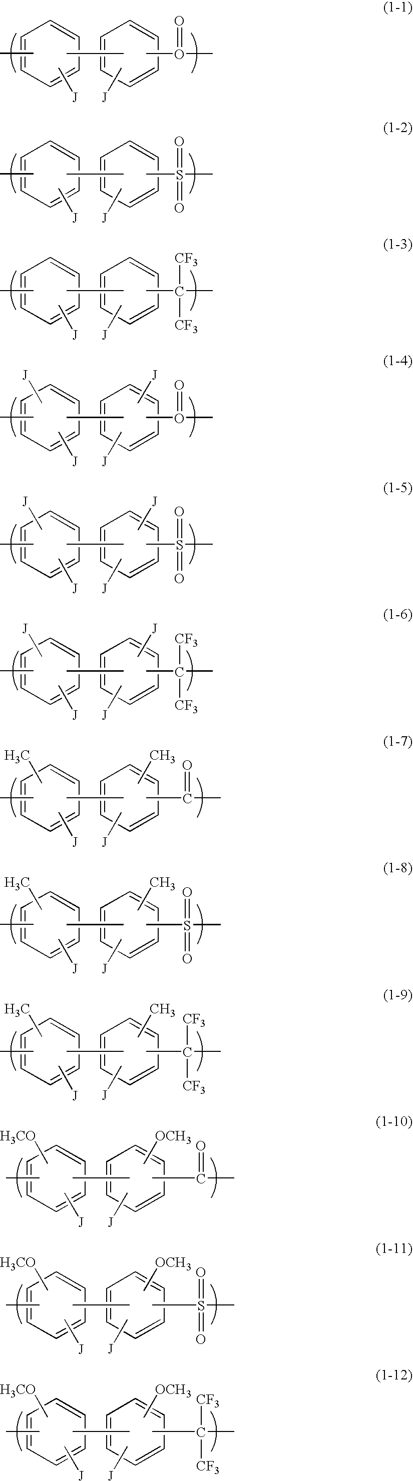

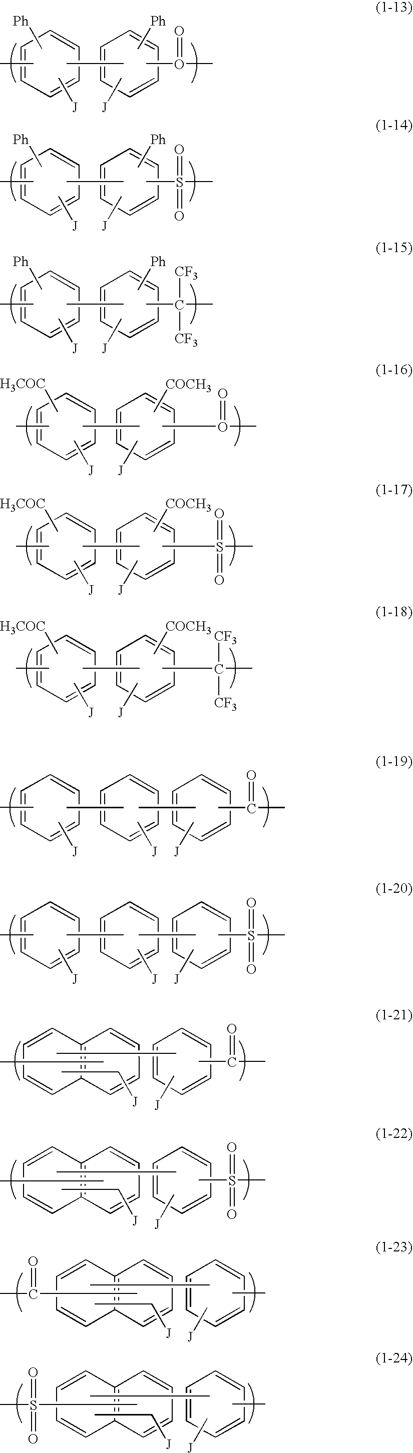

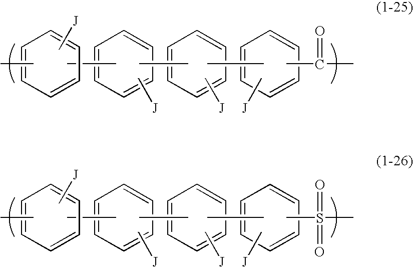

In the foregoing (1-1) to (1-26), J represents an ion-exchange group, or a group having an ion-exchange group, specifically, it is a group selected from the following groups. Additionally, a plurality of Js in the same structural unit may be the same or different from each other.

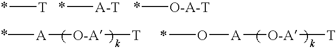

In the formula, A and A′ each independently represent an alkylene group having 1 to 6 carbon atoms, or a fluorine-substituted alkylene group having 1 to 6 carbon atoms, and when a plurality of A's are present, they may be the same or different; k represents an integer of 1 to 4; T represents an ion-exchange group; and * represents a bonding hand.

Additionally, a “fluorine-substituted alkylene group” described above means a group in which hydrogen atoms bonded with a carbon atom of an alkylene group are partly or wholly replaced by fluorine atoms.

The polymer of the present invention includes a structural unit expressed by the foregoing general formula (1a), preferably a structural unit expressed by the foregoing general formula (1) as a structural unit having an ion-exchange group exhibiting ionic conductivity, The introduction amount of the ion-exchange group is preferably 0.5 to 4.0 meq/g when it is expressed by ion-exchange capacity. When the introduction amount is not less than 0.5 meq/g, ionic conductivity is improved more, and it is preferable because functions as a polymer electrolyte for a fuel cell become more excellent. On the other hand, when the ion-exchange capacity is not more than 4.0 meq/g, it is preferable because water resistance becomes better. Additionally, it is more preferable that the ion-exchange capacity is 1.0 to 3.0 meq/g.

Further, as a suitable polymer, a segment composed of a structural unit expressed by the foregoing general formula (1), namely, a polymer having a segment expressed by the following general formula (2) in the molecule is listed. Such a polymer is more preferable because ionic conductivity is excellent in particular.

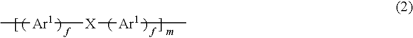

In the formula, Ar¹ and X have the same meanings as the above; f represents an integer of 1 or more, and two fs may be the same or different from each other; and m represents the number of repeating units.

m represents the number of repeating units of the structural units in parentheses in the foregoing general formula (2), m is preferably an integer of 5 or more, more preferably in a range of 5 to 1000, and further preferably 10 to 500. When the value of m is 5 or more, a higher level of proton conductivity is obtained, and when the value of m is not more than 1000, it is preferable because production of such a segment becomes easier.

The segment expressed by the foregoing general formula (2) is preferably a segment in which Ar¹ of the segment is an aromatic group expressed by the following general formula (4). Such a segment is preferable because it can be easily produced by using materials easily available from the market. Additionally, a suitable example regarding the production will be described later.

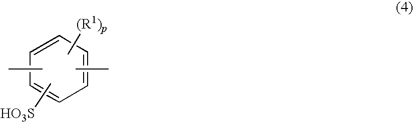

In the formula, R¹ is a fluorine atom, an alkyl group having 1 to 20 carbon atoms that may have a substituent, an alkoxy group having 1 to 20 carbon atoms that may have a substituent, an aryl group having 6 to 20 carbon atoms that may have a substituent, an aryloxy group having 6 to 20 carbon atoms that may have a substituent, or an acyl group having 2 to 20 carbon atoms that may have a substituent; and p is 0 or 1.

R¹ in the foregoing general formula (4) is a substituent selected from an alkyl group, an alkoxy group, an aryl group and an acyl group, and such a substituent is the same as one exemplified as a substituent of the above-described Ar¹, and a group not disturbing the polymerization reaction in the production method to be described later. p showing the number of the substituents is 0 or 1, particularly preferably p is 0, and that is, the aromatic group does not have such a substituent.

When the polymer of the present invention is a polymer which has a segment expressed by the foregoing general formula (2) as a segment having an ion-exchange group, also has a segment substantially not having an ion-exchange group, and the copolymerization mode is block copolymerization (hereinafter, simply called a “block copolymer”), it is preferable because the water uptake characteristic tends to be improved. When such a block copolymer is used a as membrane, it forms a microphase-separated structure in which a segment having an ion-exchange group and a segment substantially not having an ion-exchange group are separated into phases being dense in respective segments, and it is easy to carry out control for forming a continuous layer each other. Thereby, both of high level of ionic conductivity and the water uptake characteristic can be satisfied.

As a structural unit composing a segment having an ion-exchange group, such a block copolymer may have a structural unit other than the foregoing general formula (1), and given that the total amount of the segments having an ion-exchange group is 100% by weight, a structural unit expressed by the general formula (1) is preferably not less than 50% by weight, further preferably not less than 70% by weight, and further preferably, a structural unit expressed by the general formula (1) is substantially 100% by weight, namely, a block copolymer in which all of the segments having an ion-exchange group are composed of the segments expressed by the general formula (2) is particularly preferable.

Additionally, as the structural unit other than a structural unit expressed by the foregoing general formula (1) composing a segment having an ion-exchange group, a structural unit expressed by the following general formula (10) is suitable.

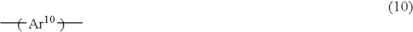

In the formula, Ar¹⁰ represents a divalent aromatic group having an ion-exchange group.

The above-described block copolymer may be a polymer having a segment expressed by the foregoing general formula (2) as a segment having an ion-exchange group and also a segment composed of a structural unit other than a structural unit expressed by the general formula (1) (hereinafter, sometimes called a “segment having other ion-exchange groups”). As a segment having other ion-exchange groups, it is a segment having not less than 0.5 ion-exchange groups when expressed by the number of ion-exchange groups present per structural unit composing the segment, preferably, one having not less than 1.0 ion-exchange group per structural unit composing the segment is listed.

The introduction amount of ion-exchange groups in the segment expressed by the general formula (2) and the segment having other ion-exchange groups in the above-described block copolymer is, when expressed by the ion-exchange group equivalent amount per the total weight of the segments, preferably 2=5 meq/g to 10.0 meq/g, further preferably 3.5 meq/g to 9.0 meq/g, and particularly preferably 4.5 meq/g to 7.0 meq/g.

When the introduction amount of ion-exchange groups is not less than 2.5 meq/g, it is preferable because ionic conductivity becomes high due to close adjacency of the ion-exchange groups. On the other hand, when the introduction amount of ion-exchange groups is not more than 10.0 meq/g, it is preferable because production is easier.

Next, a segment substantially not having an ion-exchange group is explained.

The segment substantially not having an ion-exchange group is one in which the amount of ion-exchange groups is not more than 0.1 per the repeating unit as described above, and it is particularly preferable when the amount of ion-exchange groups per structural unit is 0, namely, there is substantially no ion-exchange group at all.

As the segment substantially not having an ion-exchange group, a segment expressed by the foregoing general formula (3) is preferable.

Herein, b, c, and d in the general formula (3) each independently represent 0 or 1. n represents an integer of 5 or more, and 5 to 200 is preferable. When the value of n is small, there is a tendency causing problems that membrane-formability and membrane strength are insufficient, or durability is insufficient, so it is particularly preferable that n is 10 or more. To make n 5 or more, preferably 10 or more, a number average molecular weight in terms of polystyrene of a block of the general formula (3) of not less than 2000, and preferably being not less than 3000 is sufficient.

Ar³, Ar⁴, Ar⁵ and Ar⁶ in the general formula (3) are a fluorine atom, an alkyl group having 1 to 20 carbon atoms that may have a substituent, an alkoxy group having 1 to 20 carbon atoms that may have a substituent, an aryl group having 6 to 20 carbon atoms that may have a substituent, an aryloxy group having 6 to 20 carbon atoms that may have a substituent, or an acyl group having 2 to 20 carbon atoms that may have a substituent, and it is particularly preferable that they are a monocyclic aromatic group. As the monocyclic aromatic group, for example, a 1,3-phenylene group, a 1,4-phenylene group and the like are listed. Here, examples of an alkyl group that may have a substituent, an alkoxy group that may have a substituent, an aryl group that may have a substituent, an aryloxy group that may have a substituent, and an acyl group that may have a substituent are the same as the ones exemplified as the substituent of the foregoing Ar¹.

Z and Z′ in the foregoing general formula (3) each independently represent an oxygen atom or a sulfur atom. Y and Y′ in the general formula (3) each independently represent a direct bond or a divalent group, and above all, preferable are —CO— (carbonyl group), —SO₂— (sulfonyl group), —C(CH₃)₂— (2,2-isopropylidene group), —C(CF₃)₂— (1,1,1,3,3,3-hexafluoro-2,2-propylidene group) or a 9,9-fluorenediyl group.

As a preferable typical example of the segment expressed by the foregoing general formula (3), the following can be mentioned. Additionally, n has the same definition as in the foregoing general formula (3).

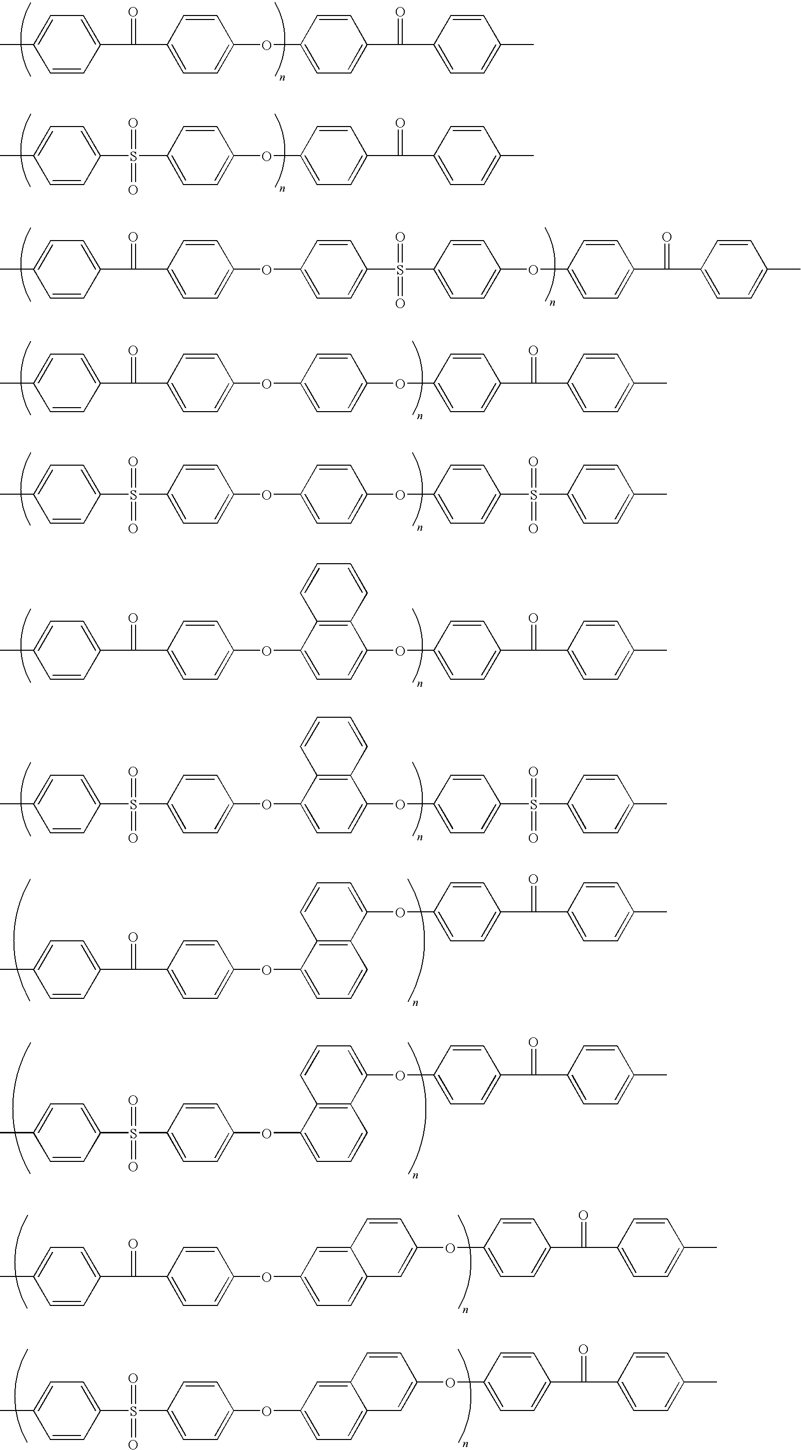

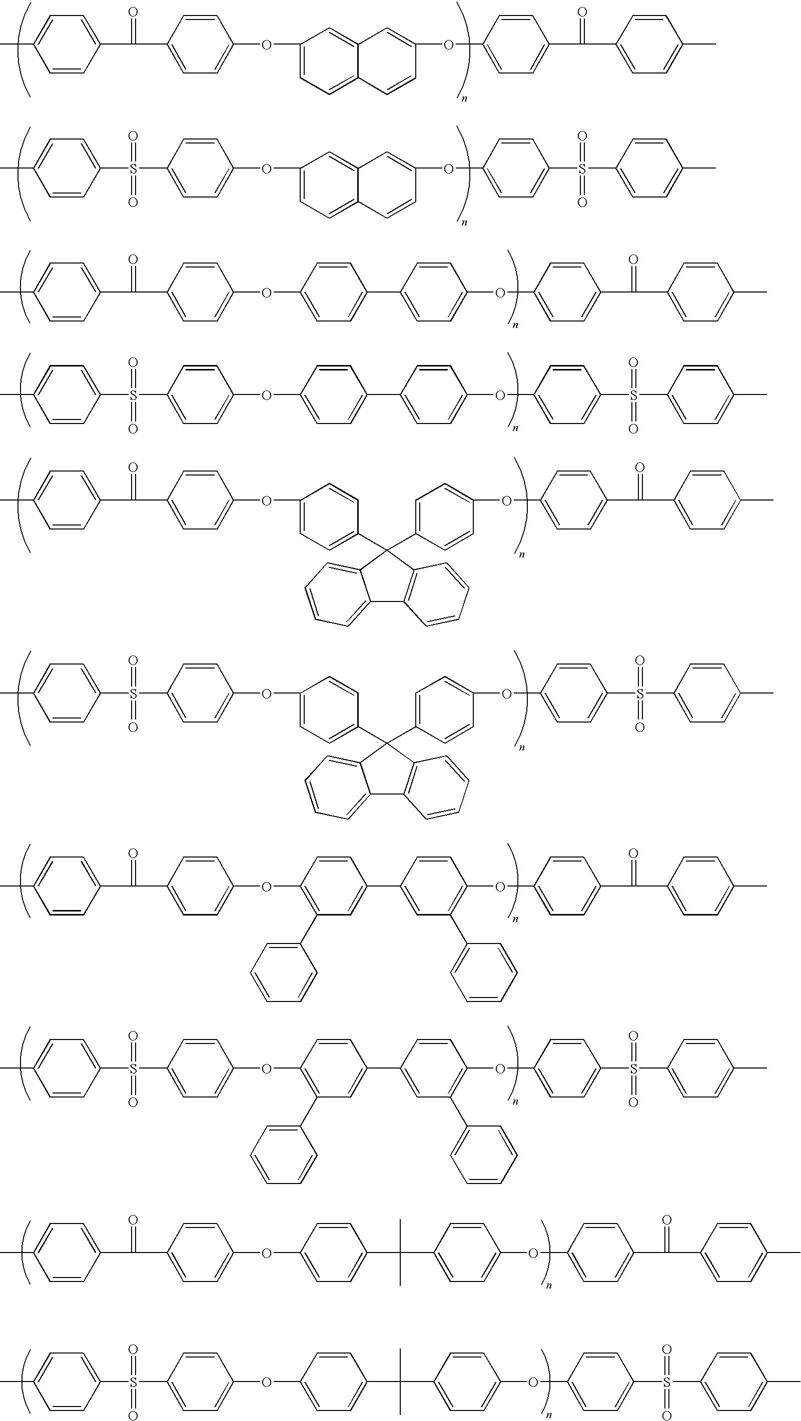

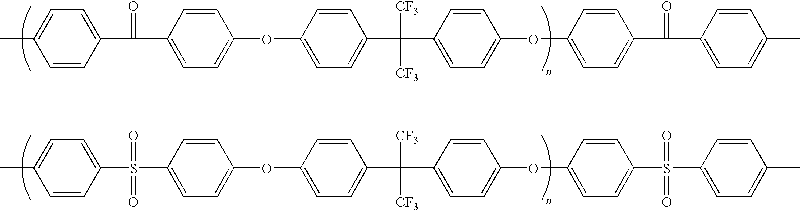

The above-described block copolymer has the segment expressed by the general formula (2) as a segment having an ion-exchange group. The introduction amount of ion-exchange groups of the block copolymer, when expressed by the ion-exchange capacity, namely the ion-exchange group equivalent amount per the total weight of the block copolymer, is preferably 0.5 meq/g to 4.0 meq/g and further preferably 1.0 meq/g to 3.0 meq/g.

When the ion-exchange capacity is not less than 0.5 meq/g, proton conductivity becomes higher, so it is preferable because functions as a polymer electrolyte for a fuel cell become more excellent. On the other hand, when the ion-exchange capacity showing the introduction amount of ion-exchange groups is not more than 4.0 meq/g, it is preferable because water resistance becomes better.

Regarding the polymer of the present invention, the molecular weight expressed by a number-average molecular weight in terms of polystyrene is preferably 5000 to 1000000, and above all, particularly preferably 15000 to 400000.

Next, a suitable production method for obtaining the polymer of the present invention is explained.

Herein, a method for introducing an ion-exchange group may be a method for polymerizing a monomer preliminarily having an ion-exchange group; or after a polymer is produced from a monomer having a position capable of introducing an ion-exchange group, a method for introducing an ion-exchange group to the position present in the polymer. Among these, the former method is more preferable because it can control the introduction amount of ion-exchange groups and substitution position precisely. As for an aromatic group Ar¹ adjacent to an electron withdrawing group X, there is a tendency that an electrophilic reaction such as sulfonation extremely hardly takes place. Therefore, as a monomer inducing a structural unit expressed by the general formula (1a) preliminarily, it is preferable to use one preliminarily having an electron withdrawing group X, and also an ion-exchange group or a group easily convertible into an ion-exchange group.

As a method for producing the polymer of the present invention using a monomer having an ion-exchange group, for example, it can be produced in such a manner that a monomer shown by the following general formula (5a) is polymerized by condensation reaction under the coexistence of a zero-valent transition metal complex;

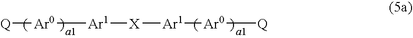

In the formula, Ar⁰, Ar¹, X and a1 have the same meanings as the above; Q represents a group leaving in condensation reaction; a plurality of Ar⁰s may be the same or different from each other; two Ar¹s may be the same or different from each other; two a1s may be the same or different from each other; and two Qs may be the same or different from each other.

A monomer expressed by the following general formula (5b):

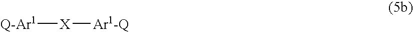

wherein Ar¹, X and Q have the same meanings as the above; and two Qs may be the same or different from each other; and

a monomer expressed by the following general formula (5c):

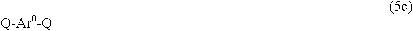

wherein Ar⁰ and Q have the same meanings as the above; and two Qs may be the same or different from each other,

are copolymerized to obtain a polymer having a structure in which A¹ and A⁰ are linked by a direct bond, having a structural unit expressed by the following general formula (1b) and a structural unit expressed by the general formula (1c), namely, a polymer having a structural unit expressed by the general formula (1a):

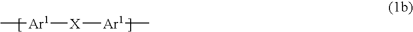

wherein Ar¹ and X have the same meanings as the above, and two Ar¹s may be the same or different from each other; and

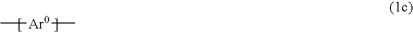

wherein Ar⁰ has the same meaning as the above.

In the case of obtaining a polymer having a structural unit expressed by the foregoing general formula (1) being a suitable polymer of the present invention, for example, a monomer expressed by the following general formula (5) may be polymerized by condensation reaction.

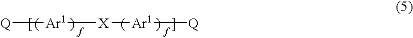

In the formula, Ar¹, X and Q have the same meanings as the above; two Qs may be the same or different from each other; two fs may be the same or different from each other; and two or more Ar¹s may be the same or different from each other.

Also, a monomer expressed by the foregoing general formula (5) and a monomer expressed by the foregoing general formula (5c) can be polymerized by condensation reaction.

In the case of producing the above-described suitable block copolymer, for example, there are exemplified a method in which under the coexistence of a zero-valent transition metal complex, a monomer expressed by the foregoing general formula (5) and a precursor of a segment (hereinafter, sometimes abbreviated as a “segment precursor”) substantially not having an ion-exchange group expressed by the following general formula (6) are polymerized by condensation reaction, and a method in which under the coexistence of a zero-valent transition metal complex, a monomer expressed by the foregoing general formula (5) is polymerized to obtain a precursor inducing a segment expressed by the general formula (2), and such a precursor is condensed with a compound expressed by the following general formula (6):

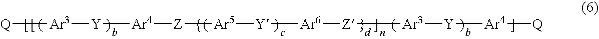

wherein Ar³, Ar⁴, Ar⁵, Ar⁶, b, c, d, n, Y, Y′, Z, Z′ and Q have the same meanings as the above.

Q in the foregoing general formulas (5), (5a), (5b), (5c) and (6) represents a group leaving in condensation reaction, and as the specific examples, for example, there are listed halogen atoms such as a chlorine atom, a bromine atom and an iodine atom, a p-toluenesulfonyloxy group, a methanesulfonyloxy group, a trifluoromethanesulfonyloxy group and the like.

Hereinafter, a production method of a block copolymer being a suitable polymer of the present invention is detailed.

Regarding the monomer expressed by the foregoing general formula (5), when it is exemplified as a sulfonic acid group being a preferable ion-exchange group, there are listed 4,4′-dichloro-22′-disulfobenzophenone, 4,4′-dibromo-2,2′-disulfobenzophenone, 4,4′-dichloro-3,3′-disulfobenzophenone, 4,4-dibromo-3,3′-disulfobenzophenone, 5,5′-dichloro-3,3′-disulfobenzophenone, 5,5′-dibromo-3,3′-disulfobenzophenone, bis(4-chloro-2-sulfophenyl)sulfone, bis(4-bromo-2-sulfophenyl)sulfone, bis(4-chloro-3-sulfophenyl)sulfone, bis(4-bromo-3-sulfophenyl)sulfone, bis(5-chloro-3-sulfophenyl)sulfone, bis(5-bromo-3-sulfophenyl)sulfone and the like.

In the case of other ion-exchange groups, it can be selected by changing a sulfonic acid group of the monomer exemplified above by an ion-exchange group such as a carboxyl group or a phosphonic acid group, and monomers having ion-exchange groups other than the above are easily available from the market or they can be produced by using a known production method.

Further, an ion-exchange group of the monomer exemplified above may be in a salt form or protected by a protecting group, and in particular, it is preferable from the viewpoint of polymerization reactivity to use a monomer in which an ion-exchange group is in a salt form, or protected by a protecting group. As the salt form, alkali metal salts are preferable, in particular, Li salt, Na salt, or K salt forms are preferable.

As a method for producing a copolymer of the present invention by carrying out introduction of ion-exchange groups after polymerization, for example, under the coexistence of a zero-valent transition metal complex, a monomer expressed by the following general formula (7) and a monomer not having an ion-exchange group as necessary are copolymerized by condensation reaction, thereafter, the production can be done by introducing an ion-exchange group in accordance with a known method.

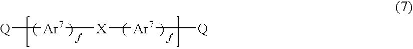

In the formula, Ar⁷ represents a divalent aromatic group capable of becoming Ar¹ of the foregoing general formula (1) by introducing an ion-exchange group; and Q, X and f have the same meanings as the above.

As a method for producing a block copolymer of the present invention, for example, under the coexistence of a zero-valent transition metal complex, a monomer expressed by the foregoing general formula (7), and a precursor of a segment substantially not having an ion-exchange group expressed by the foregoing general formula (6) instead of a monomer not having an ion-exchange group are copolymerized by condensation reaction, thereafter, the production can be done by introducing an ion-exchange group in accordance with a known method.

Herein, Ar⁷ may be substituted by a fluorine atom, an alkyl group having 1 to 20 carbon atoms, an alkoxy group having 1 to 20 carbon atoms, an aryl group having 6 to 20 carbon atoms, an aryloxy group having 6 to 20 carbon atoms, or an acyl group having 2 to 20 carbon atoms, and Ar⁷ is a divalent monocyclic aromatic group having a structure capable of introducing at least one ion-exchange group. As the divalent monocyclic aromatic group, for example, a 1,3-phenylene group, a 1,4-phenylene group and the like are listed. As an alkyl group having 1 to 20 carbon atoms that may have a substituent, an alkoxy group having 1 to 20 carbon atoms that may have a substituent, an aryl group having 6 to 20 carbon atoms that may have a substituent, an aryloxy group having 6 to 20 carbon atoms that may have a substituent, and an acyl group having 2 to 20 carbon atoms that may have a substituent, the same ones as exemplified as the substituent of the foregoing Ar¹ are listed.

The structure capable of introducing an ion-exchange group in Ar⁷ shows that it has a hydrogen atom directly bonded with an aromatic ring, or it has a substituent convertible into an ion-exchange group. The substituent convertible into an ion-exchange group is not particularly limited as long as it does not disturb polymerization reaction, and for example, a mercapto group, a methyl group, a formyl group, a hydroxyl group, a bromo group and the like are listed. In the case of electrophilic substitution reaction like introduction of a sulfonic acid group to be described later, a hydrogen atom bonded with an aromatic ring can be regarded as a substituent convertible into an ion-exchange group. Additionally, as a specific example of the monomer expressed by the general formula (7), for instance, there is listed a compound having a substituent convertible into an ion-exchange group exemplified above, the compound being selected from 3,3′-dichlorobenzophenone, 3,3′-dibromobenzophenone, 4,4′-dichlorobenzophenone, 4,4′-dibromobenzophenone, bis(3-chlorophenyl)sulfone, bis(3-bromophenyl)sulfone, bis(4-chlorophenyl)sulfone and bis(4-bromophenyl)sulfone.

As a method for introducing an ion-exchange group, in the case of a sulfonic acid group, there can be listed a method in which by dissolving or dispersing a copolymer obtained by polymerization in concentrated sulfuric acid, or after dissolving the copolymer at least partially in an organic solvent, by the action of concentrated sulfuric acid, chlorosulfuric acid, fuming sulfuric acid, sulfur trioxide or the like, a hydrogen atom is converted into a sulfonic acid group.

When a monomer expressed by the foregoing general formula (7) has a mercapto group, a copolymer having a mercapto group can be obtained after the completion of polymerization reaction, and the mercapto group can be converted into a sulfonic acid group by oxidation reaction. In the condensation reaction, it is preferable that a mercapto group is protected by a protecting group.

Next, as an example of a method for introducing a carboxyl group, there are listed known methods including a method of converting a methyl group or a formyl group into a carboxyl group by oxidation reaction, and a method in which a bromo group is changed to —MgBr by the action of Mg, then, converted into a carboxyl group by the action of carbon dioxide.

As examples of a method for introducing a phosphonic acid group, there are listed known methods: a method in which a bromo group is changed to a diethyl phosphonate group by the action of trialkyl phosphite under the coexistence of a nickel compound such as nickel chloride, then, the group is converted into a phosphonic acid group by hydrolysis; a method in which under the coexistence of a Lewis acid-catalyst, a C—P bond is formed using phosphorous trichloride, phosphorous pentachloride or the like, subsequently converted into a phosphonic acid group by oxidation and hydrolysis as necessary; and a method of converting a hydrogen atom into a phosphonic acid group by the action of an anhydride of phosphoric acid at high temperature.

As examples of a method for introducing a sulfonimide group, there are listed known methods including a method in which the foregoing sulfonic acid group is converted into a sulfonimide group by condensation reaction or substitution reaction.

In this way, the polymer of the present invention can be produced in such a manner that from a monomer having a substituent convertible into an ion-exchange group or a polymer having a substituent convertible into an ion-exchange group being obtained by polymerizing such a monomer, such a substituent is converted into an ion-exchange group, as described above. In the case where introduction of an ion-exchange group is an electrophilic substitution reaction, Ar⁷ adjacent to X relatively hardly undergoes an electrophilic substitution reaction, so it is preferable to introduce an ion-exchange group by a means other than using an electrophilic substitution reaction.

Next, suitable typical examples of the segment precursor expressed by the foregoing general formula (6) are mentioned. In these examples, Q has the same meaning as the above.

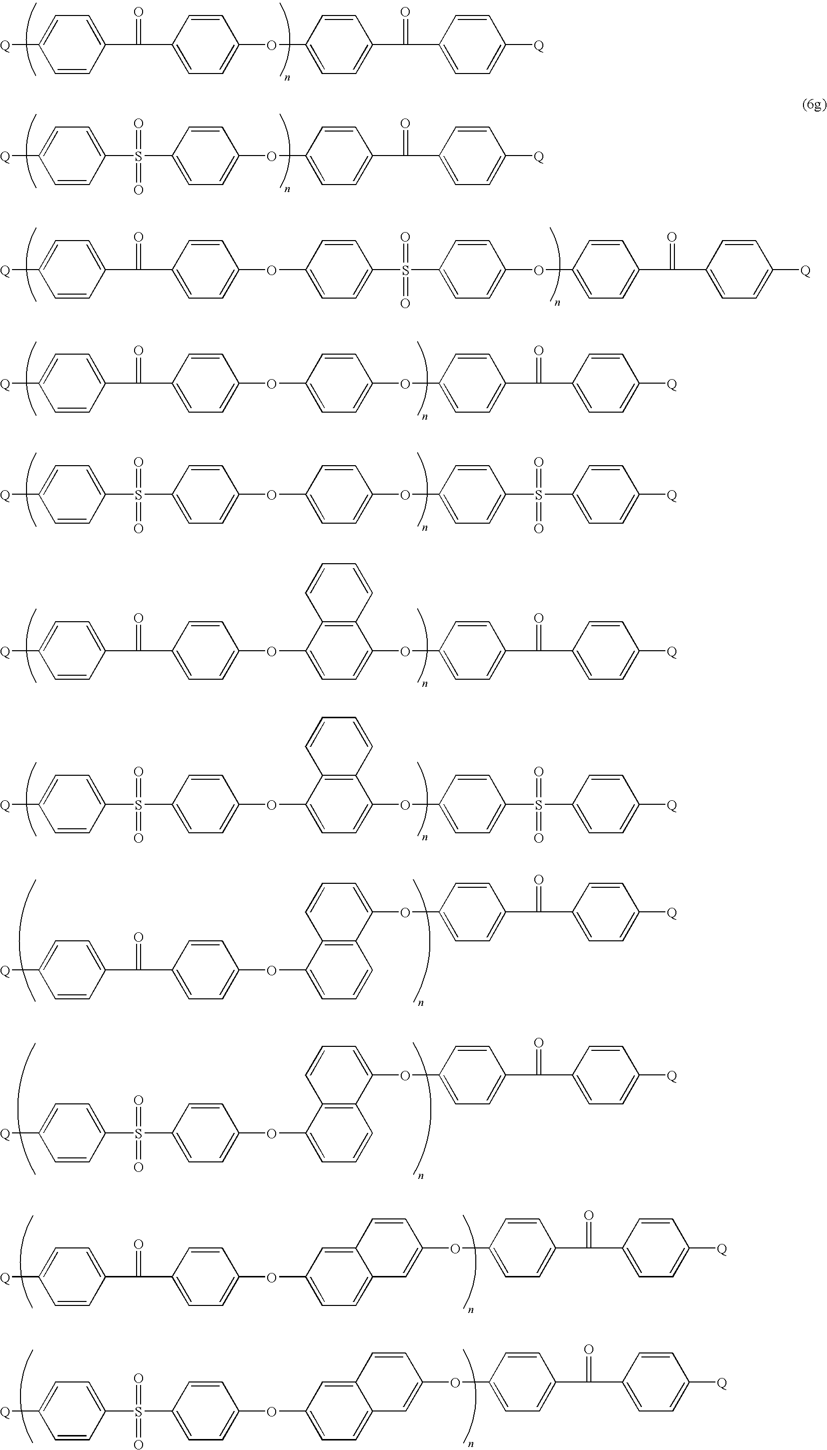

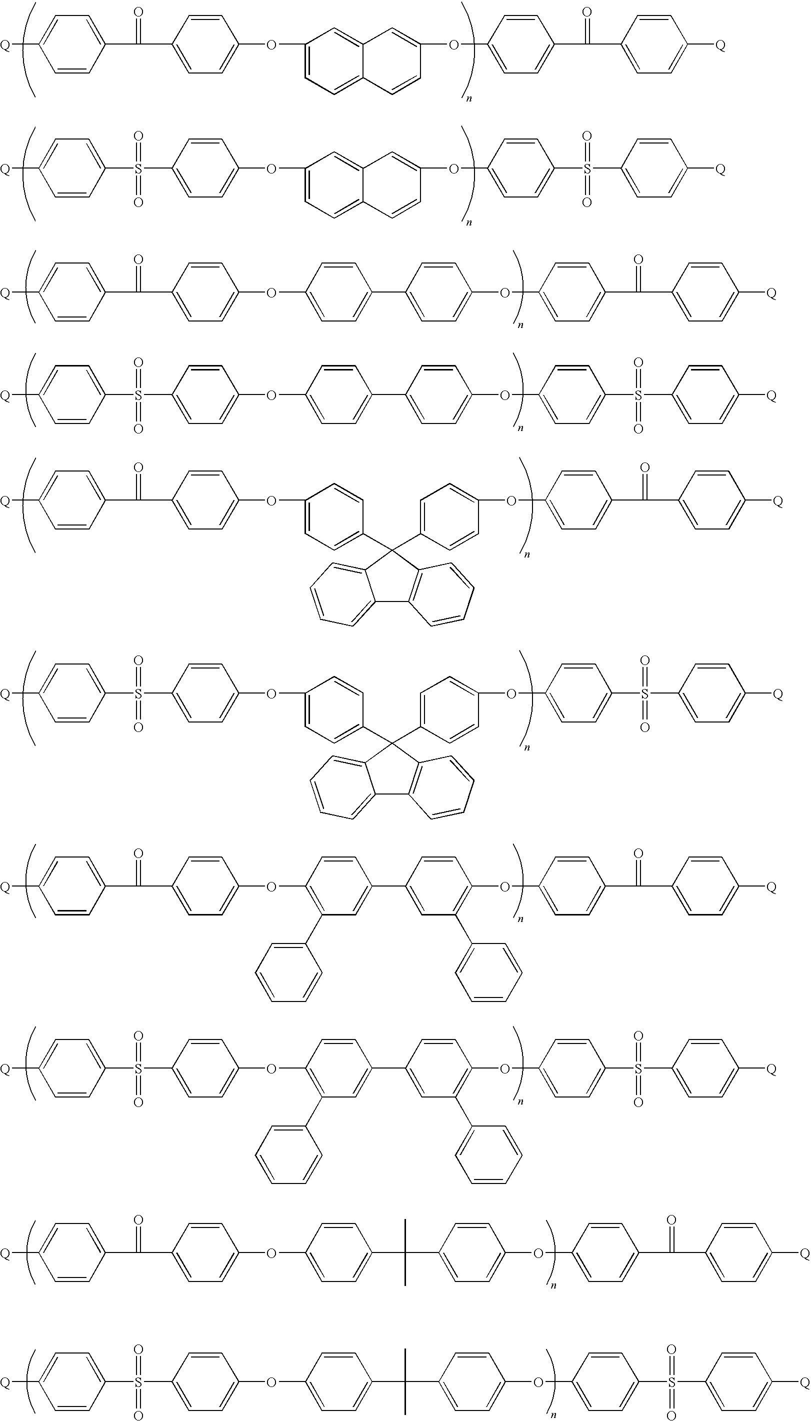

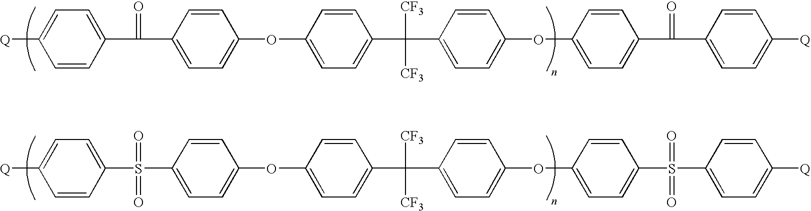

Such exemplified compounds are easily available from the market or can be produced using raw materials easily available from the market. For example, polyethersulfone having a leaving group Q at terminals shown by the foregoing (6a) is available as commercial products such as Sumikaexcel PES manufactured by Sumitomo Chemical Co., Ltd., and this can be used as a segment precursor expressed by the general formula (6). n has the same meaning as the above, and these compounds with a number average molecular weight in terms of polystyrene of not less than 2000, preferably of not less than 3000 are selected.

Polymerization by condensation reaction is carried out under the coexistence of a zero-valent transition metal complex.

The above-described zero-valent transition metal complex is one in which a halogen or a ligand to be described later is coordinated to a transition metal, and one having at least one ligand to be described later is preferable. The zero-valent transition metal complex may be either a commercial product or one synthesized separately.

As a synthesis method of a zero-valent transition metal complex, for example, there are listed conventional methods including a method in which a transition metal salt or a transition metal oxide is reacted with a ligand. The zero-valent transition metal complex synthesized may be used after taking it out or may be used in situ without taking it out.

As the ligand, for example, there are listed, acetate, acetylacetonato, 2,2′-bipyridyl, 1,10-phenanthroline, methylenebisoxazoline, N,N,N′,N′-tetramethylethylenediamine, triphenylphosphine, tritolylphosphine, tributylphosphine, triphenoxyphosphine, 1,2-bisdiphenylphosphinoethane, 1,3-bisdiphenylphosphinopropane and the like.

As the zero-valent transition metal complex, for example, a zero-valent nickel complex, a zero-valent palladium complex, a zero-valent platinum complex, a zero-valent copper complex and the like are listed, Among the transition metal complexes, a zero-valent nickel complex 5 and a zero-valent palladium complex are preferably used, and a zero-valent nickel complex is more preferably used.

As the zero-valent nickel complex, for example, bis(1,5-cyclooctadiene) nickel (0), (ethylene)bis(triphenylphosphine)nickel (0), tetrakis(triphenylphosphine)nickel (0) and the like are listed, above all, bis(1,5-cyclooctadiene)nickel (0) is preferably used from the viewpoints of reactivity, the yield of the polymer and the increase in molecular weight of the polymer.

As the zero-valent palladium complex, for example, tetrakis(triphenylphosphine)palladium (0) is listed.

These zero-valent transition metal complexes may be used by synthesizing them as described above, or ones available as commercial products may be used.

As a synthesis method of a zero-valent transition metal complex, for example, there are listed conventional methods including a method in which a transition metal compound is made to be a zero-valent compound by a reducing agent such as zinc or magnesium. The zero-valent transition metal complex synthesized may be used after taking it out or may be used in situ without taking it out.

In the case where a zero-valent transition metal complex is generated from a transition metal compound by a reducing agent, as the transition metal compound used, generally, a divalent transition metal compound is used, but a zero-valent compound can also be used. Above all, a divalent nickel compound and a divalent palladium compound are preferable. As the divalent nickel compound, there are listed nickel chloride, nickel bromide, nickel iodide, nickel acetate, nickel acetylacetonato, nickel bis(triphenylphosphine) chloride, nickel bis(triphenylphosphine) bromide, nickel bis(triphenylphosphine) iodide and the like, and as the divalent palladium compound, palladium chloride, palladium bromide, palladium iodide, palladium acetate and the like are listed.

As a reducing agent, zinc, magnesium, sodium hydride, hydrazine and derivatives thereof, lithium aluminum hydride and the like are listed. As necessary, ammonium iodide, trimethylammonium iodide, triethylammonium iodide, lithium iodide, sodium iodide, potassium iodide and the like can be concomitantly used.

In condensation reaction using the above-described transition metal complex, from the viewpoint of improvement in the yield of the polymer, it is preferable to add a compound convertible into a ligand of a zero-valent transition metal complex. The compound to be added may be the same as or different from the ligand of the transition metal complex used.

As examples of compounds convertible into the ligand, the foregoing compounds exemplified as ligands are listed, and triphenylphosphine and 2,2′-bipyridyl are preferable from the points of versatility, cheapness, reactivity of a condensation agent, the yield of the polymer and the increase in molecular weight of the polymer. In particular, when 2,2′-bipyridyl is combined with bis(1,5-cyclooctadiene)nickel (0), improvement in the yield of the polymer and the increase in molecular weight of the polymer are achieved, so that this combination is preferably used. The addition amount of the ligand is generally about 0.2 to 10 molar times on a transition metal atomic basis relative to the zero-valent transition metal complex, and preferably used by about 1 to 5 molar times.

The amount of use of the zero-valent transition metal complex is not less than 0.1 molar times relative to the whole molar quantity of the compound shown by the foregoing general formula (5) and/or the compound shown by the foregoing general formula (7), other monomers copolymerized as necessary, and/or the precursor shown by the foregoing general formula (6) (hereinafter called the “whole molar quantity of all the monomers”). When the amount of use is too small, the molecular weight tends to be small, it is preferably not less than 1.5 molar times, more preferably not less than 1.8 molar times, and further more preferably not less than 2.1 molar times. The upper limit of the amount of use is not particularly restricted, but when the amount of use is too large, post handling tends to be tedious, thus, not more than 5.0 molar times is preferable.

Additionally, in the case where a zero-valent transition metal complex is synthesized from a transition metal compound using a reducing agent, the amount may be set for the amount of a zero-valent transition metal complex produced to be in the above-described range, for example, the amount of the transition metal compound may be not less than 0.01 molar times relative to the whole molar quantity of all the monomers, and preferably not less than 0.03 molar times. The upper limit of the amount of use is not restricted, but when the amount of use is too large, post handling tends to be tedious, thus, not more than 5.0 molar times is preferable. The amount of use of the reducing agent may be, for example, not less than 0.5 molar times relative to the whole molar quantity of all the monomers, and preferably not less than 1.0 molar times. The upper limit of the amount of use is not restricted, but when the amount of use is too large, post handling tends to be tedious, and thus, not more than 10 molar times is preferable.

The reaction temperature is generally in a range of 0 to 250° C., but to increase the molecular weight of a polymer produced, it is preferable to mix a zero-valent transition metal complex with a compound shown by the foregoing general formula (5) and/or a compound shown by the foregoing general formula (7), other monomers copolymerized as necessary, and/or a precursor shown by the foregoing general formula (6) at a temperature of not less than 45° C. The preferable mixing temperature is generally 45° C. to 200° C., and about 50° C. to 100° C. is particularly preferable. After mixing a zero-valent transition metal complex, a compound shown by the foregoing general formula (5) and/or a compound shown by the foregoing general formula (7), other monomers not having an ion-exchange group as necessary, and/or a precursor shown by the foregoing general formula (6), the mixture is reacted generally at about 45° C. to 200° C., preferably at about 50° C. to 100° C. The reaction time is generally about 0.5 to 24 hours.

A method for mixing a zero-valent transition metal complex with a compound shown by the foregoing general formula (5) and/or a compound shown by the foregoing general formula (7), other monomers copolymerized as necessary, and/or a precursor shown by the foregoing general formula (6) may be a method in which one is added to the other, or a method in which both are added in a reaction vessel at the same time. Upon adding the components, they may be added at one time, but it is preferable to add them little by little in consideration of heat generation, and it is also preferable to add them under the coexistence of a solvent.

These condensation reactions are generally carried out under the presence of a solvent. As the solvent, for example, there are exemplified aprotic polar solvents such as N,N-dimethylformamide (DMF), N,N-dimethylacetamide (DMAc), N-methylpyrrolidone (NMP), dimethyl sulfoxide (DMSO) and hexamethylphosphoric triamide; aromatic hydrocarbon type solvents such as toluene, xylene, mesitylene, benzene and n-butylbenzene; ether type solvents such as tetrahydrofuran, 1,4-dioxane, dibutyl ether, tert-butyl methyl ether, dimercaptoethane and diphenyl ether; ester type solvents such as ethyl acetate, butyl acetate and methyl benzoate; halogenated alkyl type solvents such as chloroform and dichloroethane, and the like. Herein, notations in parentheses show brevity codes of the solvents, and in the following description, these brevity codes may be used sometimes.

To more increase the molecular weight of a polymer produced, since a polymer is preferably dissolved sufficiently, tetrahydrofuran, 1,4-dioxane, DMF, DMAc, NMP, DMSO and toluene being good solvents for polymers are preferable. These can be used in a mixture of two kinds or more. Above all, DMF, DMAc, NMP, DMSO and a mixture of two kinds or more thereof are preferably used.

The amount of the solvent is not particularly limited, but, too low a concentration may make recovery of the polymer compound produced difficult, whereas too high a concentration may make stirring difficult, thus, when the whole quantity of a solvent, a compound shown by the foregoing general formula (5) and/or a compound shown by the foregoing general formula (7), other monomers copolymerized as necessary, and/or a precursor shown by the foregoing general formula (6) is set to 100% by weight, the amount of the solvent used is preferably 99.95 to 50% by weight, and more preferably 99.9 to 75% by weight.

In this way, a polymer of the present invention, in particular, a preferable block copolymer is obtained, and a common procedure can be adopted for taking out the produced copolymer from a reaction mixture. For example, a poor solvent can be added to precipitate a polymer, and a target product can be taken out by filtration or the like. As necessary, the product can be further purified by a conventional purification method such as washing with water or reprecipitation using a good solvent and a poor solvent.

In the case where a sulfonic acid group of the polymer produced is in a salt form, in order to use the polymer as a member of fuel cells, it is preferable that a sulfonic acid group is converted into a free acid form, and conversion into a free acid is possible generally by washing with an acidic solution. As the acid used, for example, hydrochloric acid, sulfuric acid, nitric acid and the like are listed, and dilute hydrochloric acid and dilute sulfuric acid are preferable.

As described above, in regard to the polymer of the present invention, the case of a block copolymer has been detailed, and polymerization of a monomer expressed by the foregoing general formula (5a), copolymerization of a monomer expressed by the foregoing general formula (5b) with a monomer expressed by the foregoing general formula (5c), and polymerization of a monomer expressed by the general formula (5) can be easily carried out when this production method is used as a reference.

Hereinafter, typical examples of a suitable block copolymer are mentioned. Herein, a segment having an ion-exchange group is exemplified as a segment composed of the foregoing suitable structural unit.

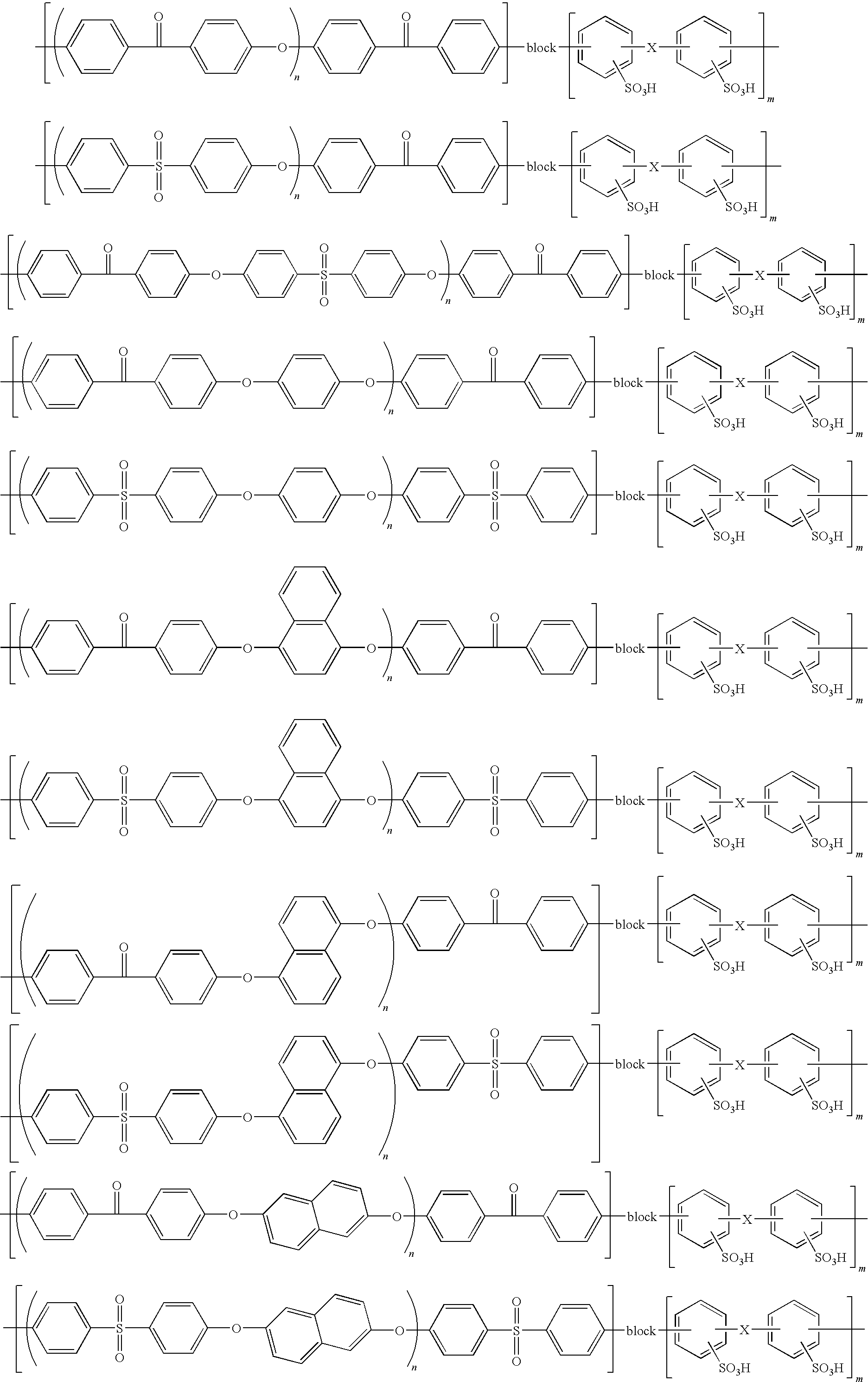

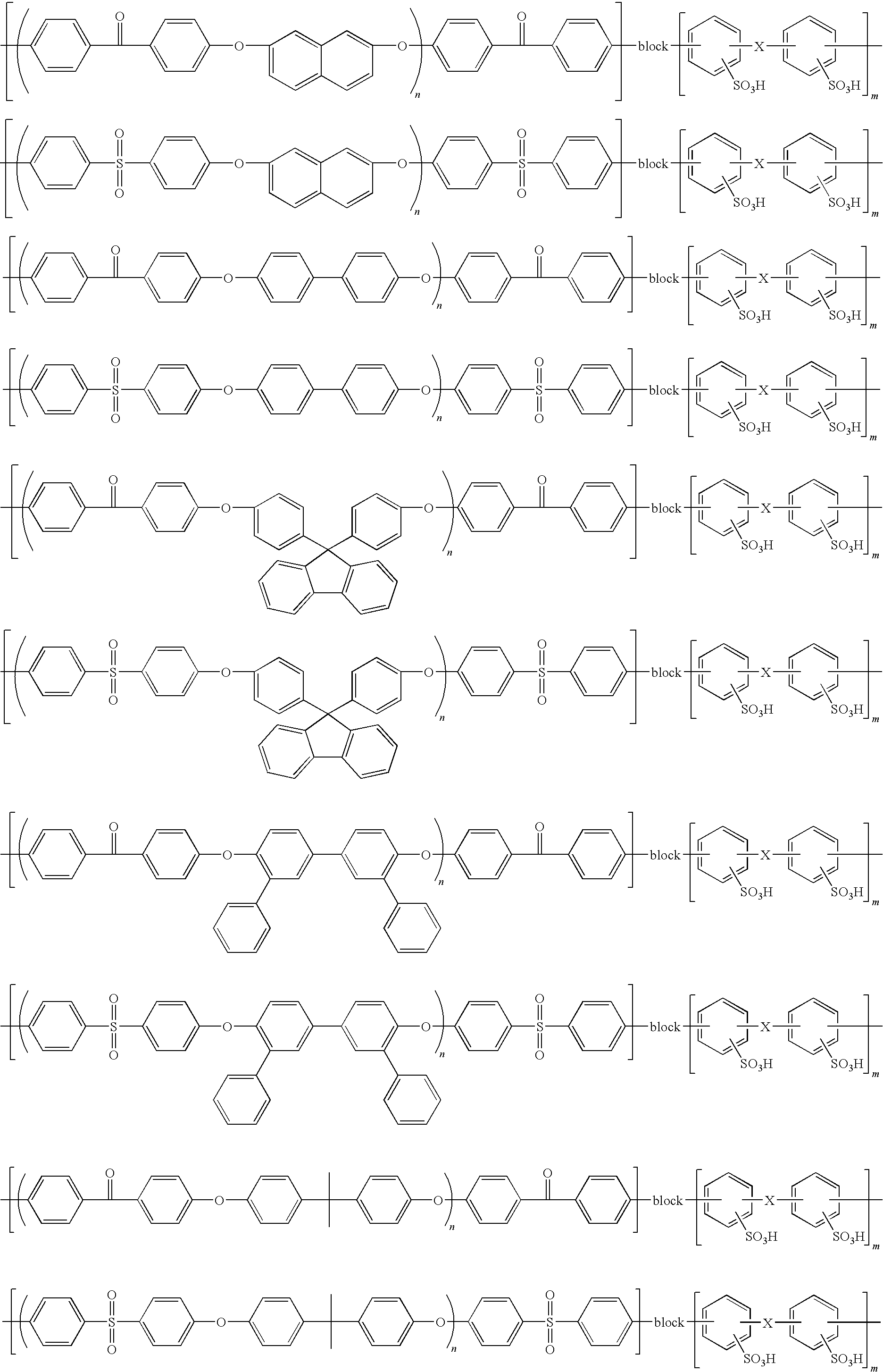

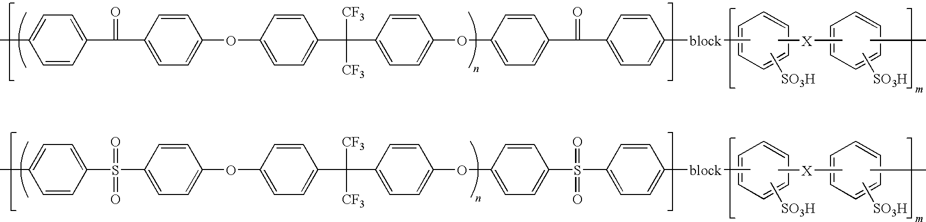

A specific example of such a block copolymer is described as a mode where a block having an ion-exchange group expressed by the foregoing general formula (2) and a block expressed by the foregoing general formula (3) are directly bonded, but may be a mode where they are bonded interposing a suitable atom or an atomic group. In a specific example of such a block copolymer, it may be a polyarylene type block where a block having an ion-exchange group has structural units expressed by:

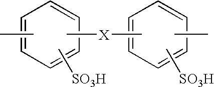

and also

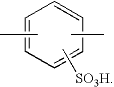

The polymers of the present invention shown above all can be suitably used as a member of fuel cells.

The polymer of the present invention is preferably used as an ion-conducting membrane of electrochemical devices such as a fuel cell, and one having an acid group being a particularly suitable ion-exchange group is preferably used as a proton-conducting membrane. Herein, the case of the above-described proton-conducting membrane is mainly explained in the following description.

In this case, the polymer of the present invention is generally used in a form of a membrane. A method for conversion into a membrane (membrane forming method) is not particularly limited, but membrane forming is preferably carried out using a method of membrane forming from a solution state (solution-cast method).

Specifically, the polymer of the present invention is dissolved in a suitable solvent, the solution is cast on a glass plate, and the solvent is removed to form a membrane. The solvent used for membrane forming is not particularly limited as long as it can dissolve the copolymer of the present invention and thereafter it can be removed away, and aprotic polar solvents such as DMF, DMAc, NMP and DMSO; chlorinated solvents such as dichloromethane, chloroform, 1,2-dichloroethane, chlorobenzene and dichlorobenzene; alcohols such as methanol, ethanol and propanol; and alkylene glycol monoalkyl ethers such as ethylene glycol monomethyl ether, ethylene glycol monoethyl ether, propylene glycol monomethyl ether and propylene glycol monoethyl ether are preferably used. These can be used alone, and as necessary, can be used in a mixture of two kinds or more of the solvents. Above all, DMSO, DMF, DMAc and NMP are preferable because of high solubility of the polymer.

The thickness of the membrane is not particularly limited, but 10 to 300 μm is preferable. When the membrane thickness is not less than 10 μm, it is preferable because practical strength is better, and a membrane of not more than 300 μm is preferable because membrane resistance becomes small, and characteristics of electrochemical devices tend to be further improved. The membrane thickness can be controlled by the concentration of the solution and the coating thickness on a base plate.

For improvement of various properties of the membrane, it is possible to add a plasticizer, a stabilizer, a mold releasing agent or the like used in general polymers into the copolymer of the present invention. A composite alloy of other polymers and the copolymer of the present invention can also be made by a method of mixing them in the same solvent and concurrently casting them or the like.

Further, to make water management easy in an application as a fuel cell, it is also known that inorganic or organic fine particles are added as a water retention agent. All these known methods can be used as long as the objects of the present invention are not damaged. For improvement in mechanical strength of the membrane or the like, it is possible to crosslink by irradiation of an electron beam, a radioactive ray or the like.

For further improvement in strength, flexibility and durability of a proton-conducting membrane using a polymer electrolyte containing the polymer of the present invention an effective component, a composite membrane can also be made in such a way that a porous base material is immersed in a polymer electrolyte containing the polymer of the present invention as an effective component to give a composite. The method of making a composite can be a known method.

The porous base material is not particularly limited as long as it satisfies the foregoing purpose of use, and for example, a porous membrane, a woven fabric, a non-woven fabric, a fibril and the like are listed, and they can be used irrespective of the shape and material. The material of a porous base material is preferably an aliphatic polymer, an aromatic polymer or a fluorine-containing polymer in view of heat resistance and the reinforcement effect on the physical strength.

In the case where a polymer electrolyte composite membrane using the polymer of the present invention is used as a proton-conducting membrane of a solid polymer fuel cell, the membrane thickness of a porous base material is preferably 1 to 100 μm, further preferably 3 to 30 μm, and particularly preferably 5 to 20 μm, the pore diameter of a porous base material is preferably 0.01 to 100 μm, further preferably 0.02 to 10 μm, and the porosity of a porous base material is preferably 20 to 98% and further preferably 40 to 95%.

When the membrane thickness of a porous base material is not less than 1 μm, the reinforcement effect of strength after complexing or the reinforcement effect providing flexibility and durability is more excellent, and gas leak (cross leak) hardly occurs. When the membrane thickness is not more than 100 μm, the electric resistance becomes lower, and the composite membrane obtained becomes better as a proton-conducting membrane of a solid polymer fuel cell When the pore diameter is not less than 0.01 μm, it becomes easier to fill the copolymer of the present invention, and when not more than 100 μm, the reinforcement effect on the copolymer becomes larger. When the porosity is not less than 20%, resistance as a proton-conducting membrane becomes smaller, and when not more than 98%, it is preferable because the strength of a porous base material itself becomes larger thereby further improving the reinforcement effect.

The polymer electrolyte composite membrane and the polymer electrolyte membrane are laminated, which can be used as a proton-conducting membrane of a fuel cell.

Next, the fuel cell of the present invention is explained.

The fuel cell of the present invention can be produced by assembling a catalyst and an electroconductive substance as a current collector to both surfaces of a polymer electrolyte membrane containing the polymer of the present invention.

Herein, the catalyst is not particularly limited as long as it can activate oxidation-reduction reaction with hydrogen or oxygen and known ones can be used, but it is preferable to use fine particles of platinum or a platinum-based alloy as a catalyst component. Fine particles of platinum or a platinum-based alloy are often used by being supported on particulate or fibrous carbon such as active carbon or graphite.

The platinum or platinum-based alloy supported by carbon is mixed with an alcohol solution of perfluoroalkylsulfonic acid resin to give a paste, which is coated on a gas diffusion layer and/or a polymer electrolyte membrane and/or a polymer electrolyte composite membrane and then dried to obtain a catalyst layer. As a specific method, for example, there can be used known methods such as a method described in J. Electrochem. Soc.: Electrochemical Science and Technology, 135(9), p. 2209, 1988.

Herein, in place of perfluoroalkylsulfonic acid resin as a polymer electrolyte, a polymer electrolyte containing the polymer of the present invention as an effective component can be used as a catalyst composition. The catalyst layer obtained by using this catalyst composition is suitable as a catalyst layer because of having good proton conductivity and dimensional stability to water uptake of the copolymer of the present invention.

A known material can be used also for the electroconductive substance as a current collector, and a porous carbon woven fabric, a carbon non-woven fabric or carbon paper is preferable because a raw material gas is efficiently transferred to a catalyst.

The thus produced fuel cell of the present invention can be used in various forms using hydrogen gas, reformed hydrogen gas or methanol as a fuel.

A solid polymer fuel cell provided with the thus produced polymer of the present invention in a proton-conducting membrane and/or a catalyst layer can be provided as a fuel cell with excellent power generation performance and long life.

In the foregoing, embodiments of the present invention have been explained but the embodiments of the present invention disclosed above are mere exemplification, and the scope of the present invention is not limited to these embodiments. The scope of the present invention is shown in claims, and further it includes all modifications within the meaning and scope equivalent to the description of claims.

Hereinafter, the present invention will be explained by using examples, but the present invention is by no means limited to these examples.

### Measurement of Molecular Weight:

By gel permeation chromatography (GPC), a number-average molecular weight (Mn) and a weight-average molecular weight (Mw) in terms of polystyrene were measured under the following conditions. Herein, as analysis conditions of the CPC, the following conditions were used, and conditions used in the measured value of molecular weight are additionally described.

### Conditions

| | |
|---|---|
| GPC measuring equipment | GPC system manufactured by Shimadzu |
| Prominence | Corporation |
| Column | TSKgel GMH_{HR-M} manufactured by |
| | Tosoh Corporation |
| Column temperature | 40° C. |
| Mobile phase solvent | DMF (added so that LiBr be 10 |
| | mmol/dm³) |
| Solvent flow rate | 0.5 mL/min |

### Measurement of Water Uptake:

A dry membrane was weighed, and from the increment of the membrane weight after being immersed in deionization water at 80° C. for 2 hours, the amount of water uptake was calculated, thereby to obtain the ratio to the dry membrane.

### Measurement of Ion-Exchange Capacity (IEC):

It was measured by a titration method,

### Measurement of Proton Conductivity:

It was measured by an alternating-current process. Dimensional change ratio upon swelling by water uptake:

A size (Ld) in the surface direction of a membrane dried under the condition at 23° C. and 50% relative humidity, and a size (Lw) in the surface direction of a membrane right after being swelled by immersion in hot water at 80° C. for one hour or more were measured, and the dimensional change ratio was calculated as follows.

Dimensional change ratio [%]=(Lw−Ld)/Ld×100[%]

### Example 1

Under an argon atmosphere, to a flask equipped with an azeotropic distillation apparatus, 130 mL of DMSO, 60 mL of toluene, 8.1 g (15.5 mmol) of 3,3′ disulfo-4,4′-dichlorodiphenylsulfone dipotassium salt, 2.3 g of polyethersulfone described below being a chloro-terminated type (Sumikaexcel PES5200P manufactured by Sumitomo Chemical Co., Ltd., Mn=3.6×10⁴, Mw=8.1×10⁴),

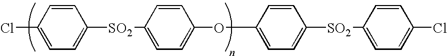

and 5.9 g (37.8 mmol) of 2,2′-bipyridyl were charged and stirred. Thereafter, the temperature of the bath was raised to 150° C., and after azeotropic dehydration of water in the system by thermally distilling toluene away, the system was cooled to 65° C. Next, 10.3 g (37.4 mmol) of bis(1,5-cyclooctadiene)nickel (0) was added thereto, and the mixture was stirred at an inner temperature of 75° C. for 5 hours. After being left standing to cool, the reaction mixture was poured in a large amount of methanol to precipitate a polymer, which was collected by filtration. Thereafter, operations of washing with 6 mol/L hydrochloric acid and filtration were repeated several times, then, washing with water was conducted till the pH of the filtrate exceeded 5, and a crude polymer obtained was dried. Thereafter, the crude polymer was dissolved in NMP, and reprecipitation purification was conducted by pouring the solution into 6 mol/L hydrochloric acid, and washing with water was conducted till the pH of the filtrate exceeded 5, then, the resulting polymer was dried under reduced pressure to obtain 3.0 g of a target block copolymer described below. The measurement result of the molecular weight is shown below.

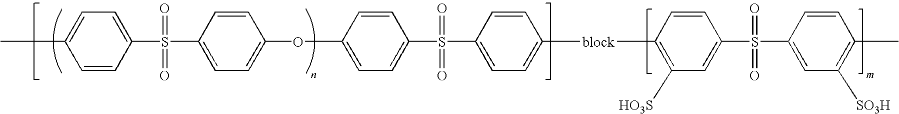

The block copolymer obtained was dissolved in NMP by a concentration of 10% by weight, thereby preparing a polymer electrolyte solution. Thereafter, the polymer electrolyte solution obtained was cast on a glass plate, and the solvent was removed by drying at 80° C. under normal pressure for 2 hours, then via treatment with hydrochloric acid and washing with ion-exchange water, thereby producing a polymer electrolyte membrane of about 40 μm in membrane thickness. The results on water uptake, IEC and dimensional change ratio are shown below.

| Mn | 1.3 × 10⁵ |
|---|---|
| Mw | 2.4 × 10⁵ |
| Water uptake | 76% |
| IEC | 1.62 meq/g |
| Dimensional change ratio | 3.5% |

On the basis of Mn in terms of polystyrene of polyethersulfone used being a terminal chlorine type, estimating from Mn and IEC of the block copolymer obtained, m is calculated to be 40 on average.

The polymer electrolyte membrane obtained was measured for proton conductivity. The proton conductivities under humidities of 90% RH, 60% RH and 40% RH at the temperature of 50° C. are shown in Table 1, and proton conductivities at temperatures of 90° C., 70° C. and 50° C. under a humidity of 90% RH are shown in Table 2.

### Example 2

Under an argon atmosphere, to a flask equipped with an azeotropic distillation apparatus, 100 mL of DMSO, 50 mL of toluene, 3.1 g (6.4 mmol) of 3,3′-disulfo-4,4′-dichlorodiphenylsulfone disodium salt, 3.8 g (15.0 mmol) of 2,5-dichlorobenzophenone and 8.4 g (53.8 mmol) of 2,2′-bipyridyl were charged and stirred. Thereafter, the temperature of the bath was raised to 150° C., and after azeotropic dehydration of water in the system by thermally distilling toluene away, the system was cooled to 65° C. Next, 14.7 g (53.4 mmol) of bis(1,5-cyclooctadiene)nickel (0) was added thereto, and the mixture was stirred at an inner temperature of 70° C. for 3 hours. After being left standing to cool, the reaction mixture was poured in a large amount of methanol to precipitate a polymer, which was collected by filtration. Thereafter, operations of washing with 6 mol/L hydrochloric acid and filtration were repeated several times, then, washing with water was conducted till the pH of the filtrate exceeded 5, and a crude polymer obtained was dried. Thereafter, the crude polymer was dissolved in NMP, and reprecipitation purification was conducted by pouring the solution into 6 mol/L hydrochloric acid, and washing with water was conducted till the pH of the filtrate exceeded 5. then, the resulting polymer was dried under reduced pressure to obtain 3.0 g of a target copolymer described below. The measurement result of the molecular weight is shown below.

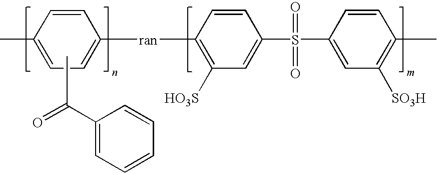

The copolymer obtained was dissolved in NMP by a concentration of 20% by weight, thereby preparing a polymer electrolyte solution. Thereafter, the polymer electrolyte solution obtained was cast on a glass plate, and the solvent was removed by drying at 80° C. under normal pressure for 2 hours, then via treatment with hydrochloric acid and washing with ion-exchange water, thereby producing a polymer electrolyte membrane of about 40 μm in membrane thickness. The results on water uptake and IEC are shown below.

| | |
|---|---|
| Mn | 1.3 × 10⁵ |
| Mw | 2.4 × 10⁵ |
| Water uptake | 125% |
| IEC | 2.34 meq/g |

The polymer electrolyte membrane obtained was measured for proton conductivity. The proton conductivities under humidities of 90% RH, 60% RH and 40% RH at the temperature of 50° C. are shown in Table 1, and proton conductivities at temperatures of 90° C., 70° C. and 50° C. under a humidity of 90% RH are shown in Table 2.

### Example 3

Under an argon atmosphere, to a flask equipped with an azeotropic distillation apparatus, 200 mL of DMSO, 120 mL of toluene, 7.7 g (15.0 mmol) of 3,3′-disulfo-4,4′-dichlorodiphenylsulfone disodium salt, 3.7 g (15.0 mmol) of sodium 2,5-dichlorobenzesulfonate, 3.3 g of polyethersulfone described below being a chloro-terminate type (Sumikaexcel PES3600P manufactured by Sumitomo Chemical Co., Ltd., Mn=2.4×10⁴, Mw=4.5×10⁴),

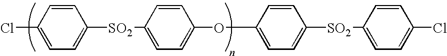

and 12.4 g (79.3 mmol) of 2,2′-bipyridyl were charged and stirred. Thereafter, the temperature of the bath was raised to 150° C., and after azeotropic dehydration of water in the system by thermally distilling toluene away, the inner temperature was cooled to 62° C. Next, 10.3 g (37.4 mmol) of bis(1,5-cyclooctadiene)nickel (0) was added thereto, and the mixture was stirred at an inner temperature of 74° C. for 3 hours. After being left standing to cool, the reaction mixture was poured in a large amount of methanol to precipitate a polymer, which was collected by filtration. Thereafter, operations of washing with 6 mol/L hydrochloric acid and filtration were repeated several times, then, washing with water was conducted till the pH of the filtrate exceeded 5, and a crude polymer obtained was dried. Thereafter, the crude polymer was dissolved in NMP, and reprecipitation purification was conducted by pouring the solution into 6 mol/L hydrochloric acid, and washing with water was conducted till the pH of the filtrate exceeded 5, then, the resulting polymer was dried under reduced pressure to obtain 5.7 g of a block copolymer assumingly having the following structure. The measurement result of the molecular weight is shown below.

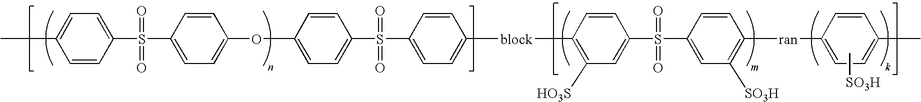

| | |
|---|---|
| Mn | 1.3 × 10⁵ |
| Mw | 2.2 × 10⁵ |

TABLE 1

| | | Proton conductivity 50° C. | | |
|---|---|---|---|---|
| | IEC | [S/cm] | | |
| | [meq/g] | 90% RH | 60% RH | 40% RH |
| Example 1 | 1.62 | 1.1E−01 | 3.4E−02 | 1.2E−02 |
| Example 2 | 2.34 | 7.7E−02 | 2.4E−02 | 5.5E−03 |

TABLE 2

| | | Proton conductivity 90% RH | | |
|---|---|---|---|---|
| | IEC | [S/cm] | | |
| | [meq/g] | 90° C. | 70° C. | 50° C. |
| Example 1 | 1.62 | 1.7E−01 | 1.4E−01 | 1.1E−01 |
| Example 2 | 2.34 | 1.2E−01 | 1.0E−01 | 7.7E−02 |

From Table 1 and Table 2, the polymer of the present invention has small humidity dependence of proton conductivity and being good, and the proton conductivity itself under low humidity is high. The polymer of the present invention is excellent in dimensional stability to water uptake, thus, it can be suitably used particularly in an application as a fuel cell.

1. A polymer having a structural unit expressed by the following general formula (1a): 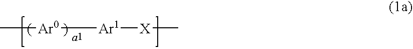
wherein a1 represents an integer of 1 or more; Ar¹ represents a divalent aromatic group having an ion-exchange group, and may have a substituent other than an ion-exchange group; Ar⁰ represents a divalent aromatic group that may have a substituent; when a1 is 2 or more, a plurality of Ar⁰s may be the same or different from each other; and x represents a divalent electron withdrawing group.

2. The polymer according to claim 1, having a structural unit expressed by the following general formula (1b) and a structural unit expressed by the following general formula (1c): 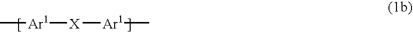
wherein Ar¹ and X have the same meanings as the above, and two Ar¹s may be the same or different from each other; and 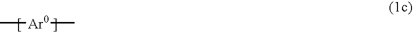
wherein Ar⁰ has the same meaning as the above.

3. The polymer according to claim 1, wherein the structural unit expressed by the foregoing general formula (1a) is a structural unit expressed by the following general formula (1): 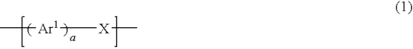
wherein a represents an integer of 2 or more; Ar¹ and X have the same meanings as the above; a plurality of Ar¹s may be the same or different from each other; and X represents a divalent electron withdrawing group.

4. The polymer according to claim 3, having a segment expressed by the following general formula (2); 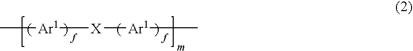
wherein Ar¹ and x have the same meanings as the above; f represents an integer of 1 or more, and two fs may be the same or different from each other; a plurality of Ar¹s may be the same or different from each other; and m represents the number of repeating units.

5. The polymer according to claim 4, wherein m is an integer of 5 or more.

6. The polymer according to any one of claims 1 to 5, wherein X is an electron withdrawing group selected from the group consisting of a carbonyl group, a sulfonyl group, and 1,1,1,3,3,3-hexafluoro-2,2-propylidene group.

7. The polymer according to any one of claims 1 to 6, wherein the ion-exchange group at Ar¹ is directly bonded with an aromatic ring composing a main chain.

8. The polymer according to any one of claims 1 to 7, wherein the ion-exchange group is an acid group selected from a sulfonic acid group, a sulfonimide group, a phosphonic acid group and a carboxyl group.

9. The polymer according to any one of claims 1 to 8, wherein Ar¹ is an aromatic group expressed by the following general formula (4): 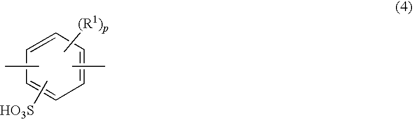
wherein R¹ is a fluorine atom, an alkyl group having 1 to 20 carbon atoms that may have a substituent, an alkoxy group having 1 to 20 carbon atoms that may have a substituent, an aryl group having 6 to 20 carbon atoms that may have a substituent, an aryloxy group having 6 to 20 carbon atoms that may have a substituent, or an acyl group having 2 to 20 carbon atoms that may have a substituent; and p is 0 or 1.

10. The polymer according to any one of claims 4 to 9, which has a segment expressed by the foregoing general formula (2) as a segment having an ion-exchange group, and further has a segment substantially not having an ion-exchange group, and wherein the copolymerization mode is block copolymerization.

11. The polymer according to claim 10, wherein the segment substantially not having an ion-exchange group is a segment expressed by the following general formula (3): 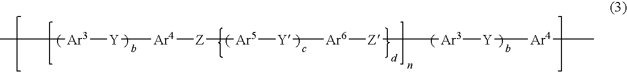
wherein b, c and d each independently represent 0 or 1, and n represents an integer of 5 or more; Ar³, Ar⁴, Ar⁵ and Ar⁶ each independently represent a divalent aromatic group, wherein these divalent aromatic groups may be substituted by an alkyl group having 1 to 20 carbon atoms that may have a substituent, an alkoxy group having 1 to 20 carbon atoms that may have a substituent, an aryl group having 6 to 20 carbon atoms that may have a substituent, an U aryloxy group having 6 to 20 carbon atom that may have a substituent, or an acyl group having 2 to 20 carbon atoms that may have a substituent; Y and Y′ each independently represent a direct bond or a divalent group; and Z and Z′ each independently represent an oxygen atom or a sulfur atom.

12. The polymer according to any one of claims 1 to 11, wherein an ion-exchange capacity is 0.5 meq/g to 4.0 meq/g.

13. A polymer electrolyte containing the polymer according to any one of claims 1 to 12 as an effective component.

14. A polymer electrolyte membrane comprising the polymer electrolyte according to claim 13.

15. A polymer electrolyte composite membrane comprising the polymer electrolyte according to claim 13 and a porous base material.

16. A catalyst composition comprising the polymer electrolyte according to claim 13 and a catalyst component.

17. A polymer electrolyte fuel cell comprising the polymer electrolyte membrane according to claim 14, or the polymer electrolyte composite membrane according to claim 15 as an ion-conducting membrane.

18. A polymer electrolyte fuel cell provided with a catalyst layer obtained by using the catalyst composition according to claim 16.
